(19) United States
(12) Patent Application Publication
(10) Pub. No.: US 2003/0099366 A1
(43) Pub. Date: May 29, 2003

(54) Earphone-based voice transmission device

(76) Inventor: Yi-Hua Peng, Chunghe City (TW)

Correspondence Address: BIRCH STEWART KOLASCH & BIRCH, PO BOX 747, FALLS CHURCH, VA, 22040-0747, US

(21) Appl. No.: 10/028,669

(22) Filed: Dec. 28, 2001

(30) Foreign Application Priority Data
Nov. 24, 2001 (TW) 90219600

(51) Int. Cl. H04R 1/10; H04R 5/02

(52) U.S. Cl. 381/74; 381/309

(57) ABSTRACT

An earphone-based voice transmission device. An earplug is placed inside a user's ear for collecting the voice generated by the eardrum. The voice is converted into an output electronic audio signal by a converter. Then, the output electronic audio signal is amplified and transmitted to a communication device for further transmission.

### BACKGROUND OF THE INVENTION

1. Field of the Invention

The present invention relates to a voice transmission device, and in particular to an earphone-based voice transmission device for receiving the voice generated by the user's eardrum and transmitting the voice to a communication device.

2. Description of the Related Art

Generally speaking, a conventional earphone-based voice transmission device uses an earphone together with an auditory tube as a speaker. The conventional earphone-based voice transmission device is only used to receive voice messages from a communication device and can not output a voice message to the communication device or others. In such cases, an additional element such as a microphone is needed in order that that a person can communicate with others. In addition to the earphone together with an auditory tube, the microphone disposed on the head or other parts of a human body causes an extra burden to the user, thus causing inconvenience of operation.

### SUMMARY OF THE INVENTION

An object of the invention is to provide an earphone-based voice transmission device for receiving the voice generated by a user's eardrum and transmitting the voice to a communication device and transmitting the voice from the communication device to the user's ear. The earphone-based voice transmission device comprises an earplug for collecting the voice generated by the user's eardrum and transmitting the voice to the user's ear; a converter connected to the earplug for converting the voice collected by the earplug into an output electronic audio signal and converting an input electronic audio signal from the communication device into the voice; and an amplifier connected to the converter by a wire for amplifying and transmitting the output electronic audio signal to the communication device.

A detailed description will be given by the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows the earphone-based voice transmission device of the present invention combined with a communication device; and

FIG. 2 shows another embodiment of the present invention.

### DETAILED DESCRIPTION OF THE PREFERRED EMBODIMENT

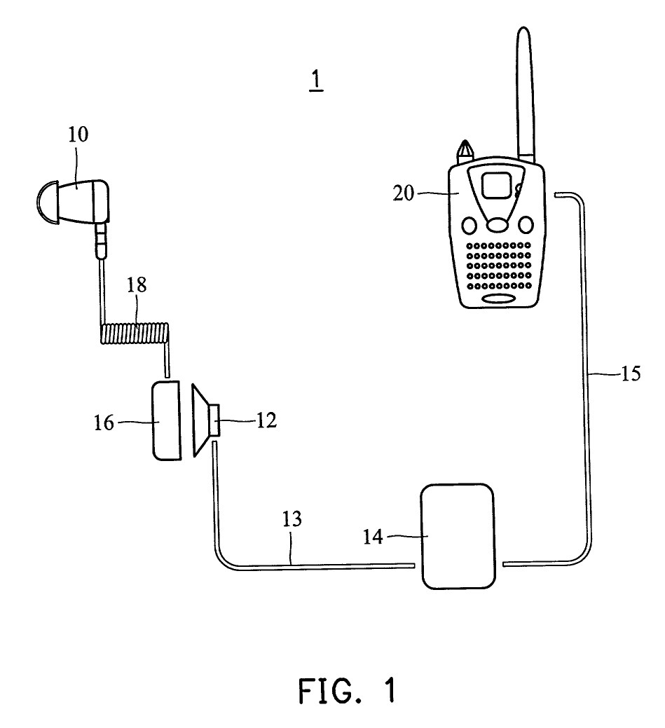

Referring to FIG. 1, the earphone-based voice transmission device 1 comprises an earplug 10, a converter 12, an amplifier 14, a voice collecting hood 16 and a voice transmitting tube 18. The communication device combined with the earphone-based voice transmission device 1 is a radio transmitter 20. The earplug 10 is connected to the voice collecting hood 16 via the voice transmitting tube 18 made of plastic or any other materials. The voice collecting hood 16 is combined with the converter 12. The converter 12 is connected to the amplifier 14 via a wire 13. The amplifier 14 is connected to the radio transmitter 20 via another wire 15.

The operation of the present device is described as follows. First, the earplug 10 is placed inside the user's ear. When the user speaks, the eardrum generates a corresponding voice. The earplug 10 collects the voice generated by the eardrum and transmits it to the voice collecting hood 16 via the voice transmitting tube 18. Then, the converter 12 combined with the voice collecting hood 16 converts the voice into an output electronic audio signal and transmits the signal to the amplifier 14 via the wire 13 so as to enable amplification. Finally, the amplified output electronic audio signal is transmitted to the radio transmitter 20 via the wire 15 such that the user can communicate with others.

Similarly, when an audio signal from outside is input, the radio transmitter 20 receives the audio signal and yields an input electronic audio signal to the converter 12. The converter 12 converts the input electronic audio signal to voice employing a reversible physical operation of a speaker or a microphone. Then, the voice is transmitted to the operator's ear via the voice collecting hood 16, the voice transmitting tube 18 and the earplug 10, sequentially.

In addition to the above description, as the radio transmitter 20 is a unidirectional communication device, that is, the radio transmitter 20 cannot be used to send out and receive voice signals simultaneously, the radio transmitter 20 only allows the user or users to participate in unidirectional communication when it is working. Therefore, a control switch (not shown) is disposed in the amplifier 14 of the earphone-based voice transmission device 1 of the invention so as to control the unidirectional transmission between the output electronic audio signal and the input electronic audio signal. To send out voice signals, the user must press the control switch on the amplifier 14 and hold it until finished. The earphone-based voice transmission device 1 only receives voice signals from outside when the switch control is not pressed down.

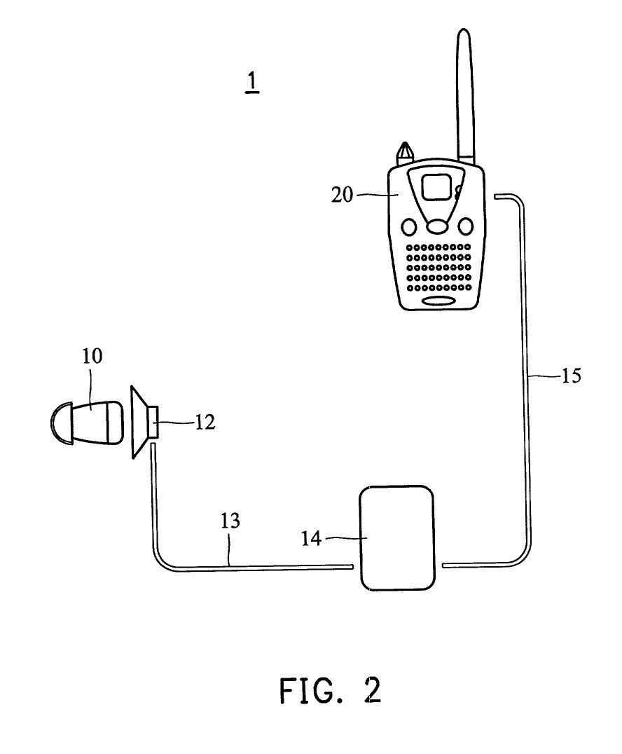

In addition, the earphone-based voice transmission device 1 can be embodied in a simplified form. Referring to FIG. 2, the simplified earphone-based voice transmission device 1 comprises the earplug 10, the converter 12 and the amplifier 14. Although the voice collecting hood 16 and the voice transmitting tube 18 have been removed from the earphone-based voice transmission device 1 of FIG. 1, the operating performance of the simplified earphone-based voice transmission device 1 of FIG. 2 is not reduced.

Similarly, when an audio signal from outside is input, the radio transmitter 20 receives the audio signal and yields an input electronic audio signal to the converter 12. The converter 12 converts the input electronic audio signal into a voice employing a reversible physical operation of a speaker or a microphone. Then, the voice is transmitted to the user's ear via the earplug 10.

In addition, the wire 13 between the converter 12 and the amplifier 14 can be removed. Namely, the amplifier 14 is wirelessly connected to the converter 12. The advantage of this structure is that it is more convenient for the user to use the earphone-based voice transmission device 1. Therefore, the amplifier 14 having the control switch can be placed on any part of the user or given to another person to operate the earphone-based voice transmission device 1.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An earphone-based voice transmission device for receiving the voice generated by a user's eardrum and transmitting the voice to a communication device and transmitting the voice from the communication device to a receiver's ear, comprising:
an earplug for collecting the voice generated by the user's eardrum and transmitting a received voice to the user's ear;
a converter connected to the earplug for converting the voice collected by the earplug into an output electronic audio signal and converting an input electronic audio signal from the communication device to voice; and
an amplifier connected to the converter for amplifying and transmitting the output electronic audio signal to the communication device.

2. The earphone-based voice transmission device as claimed in claim 1, further comprising a voice collecting hood connected to the earplug and combined with the converter for further collecting the voice collected by the earplug and receiving the voice converted by the converter.

3. The earphone-based voice transmission device as claimed in claim 2, further comprising a voice transmitting tube connected to the earplug and the voice collecting hood for transmitting the voice collected by the earplug to the voice collecting hood and transmitting the voice collected by the voice collecting hood to the earplug.

4. The earphone-based voice transmission device as claimed in claim 1, 2 or 3, wherein the amplifier is wirelessly connected to the converter.

5.The earphone-based voice transmission device as claimed in claim 1, wherein the amplifier further comprises a control switch for controlling the unidirectional transmission between the output electronic audio signal and the input electronic audio signal.
